(19) United States
(12) Patent Application Publication
(10) Pub. No.: US 2011/0103172 A1
(43) Pub. Date: May 5, 2011

(54) HIGH PERFORMANCE GREEN CONCRETE MIXER AND HIGH PERFORMANCE MIXING METHOD FOR GREEN CONCRETE

(75) Inventors: Chao-Lung Hwang, Taipei City (TW); Sung-Yi Lin, Taoyuan County (TW)

(73) Assignee: National Taiwan University of Science and Technology, Taipei (TW)

(21) Appl. No.: 12/749,478

(22) Filed: Mar. 29, 2010

(30) Foreign Application Priority Data
Nov. 3, 2009 (TW) 98137313

(51) Int. Cl. B28C 9/00

(52) U.S. Cl. 366/2; 366/14

(57) ABSTRACT

A high performance green concrete mixer and a high performance mixing method of green concrete are provided. The high performance green concrete mixer includes a pan mixer, plural drum mixers and a funnel. Each of the drum mixers is inclined relative to the pan mixer, while the funnel is connected between the pan mixer and the drum mixers.

### CROSS-REFERENCE TO RELATED APPLICATION

This application claims the priority benefit of Taiwan application serial no. 98137313, filed on Nov. 3, 2009. The entirety of the above-mentioned patent application is hereby incorporated by reference herein and made a part of specification.

### BACKGROUND OF THE INVENTION

1. Field of the Invention

The present invention relates to an apparatus and a method, and more particularly to a high performance green concrete mixer and a high performance mixing method for green concrete.

2. Description of Related Art

A conventional single shaft mixer incapable of mixing a concrete efficiently and cost effectively in low consumption of water and cement requires long mixing time and suffers from wearing, high power and energy consumption, and thus a powerful mixer is needed to meet the requirements of high durability, high strength, viscosity, low energy consumption and carbon emissions, and high efficiency of cement concrete. The existing concrete mixers are generally categorized into the pan type and the twin-shaft type, while both of the two have drawbacks of high power and energy consumption and high probability of wearing or damage, and the existing of concrete mixers are only available for being used in a rich mix concrete with high water content and cement content. Therefore, cracks are liable to occur in the conventional concrete constructions. In addition, the existing concrete mixers are not suitable for mixing the high performance concrete and the self-consolidating concrete of low liquid and heavy aggregate.

### SUMMARY OF THE INVENTION

The present invention is related to a high performance green concrete mixer for improving mixing efficiency and cost effectively.

As embodied and broadly described herein, a high performance green concrete mixer comprising a pan mixer, a plurality of drum mixers and funnel is provided. Each of the drum mixers is inclined relative to the pan mixer, and the funnel is connected between the pan mixer and the drum mixers.

In an embodiment of the high performance green concrete mixer of the present invention, the pan mixer has a plurality of material inlets.

In an embodiment of the high performance green concrete mixer of the present invention, a central axis of each of the drum mixers and a bottom surface of the pan mixer includes an acute angle.

In an embodiment of the high performance green concrete mixer of the present invention, each of the drum mixers has a plurality of rifling structures disposed radially therein.

In an embodiment of the high performance green concrete mixer of the present invention, the funnel has a coarse aggregate and fiber inlet, through which coarse aggregate and fiber are poured into the funnel.

A high performance mixing method for green concrete is also provided herein. The method comprises at least following steps: providing a high performance green concrete mixer, wherein the high performance green concrete mixer comprises a pan mixer and a plurality of drum mixers, and each of the drum mixers is inclined relative to the pan mixer; and, pouring a cement mortar from the pan mixer into the drum mixers, the cement mortar can be uniformly mixed with coarse aggregate or fiber due to a potential of the cement mortar in the drum mixers is increased by means of the inclination of the drum mixers relative to the pan mixer.

In an embodiment of the high performance mixing method for green concrete of the present invention, the step of disposing each of the drum mixers inclined relative to the pan mixer comprises orienting a central axis of each of the drum mixers to include an acute angle with a bottom surface of the pan mixer.

In an embodiment of the high performance mixing method for green concrete of the present invention, a method of increasing the potential of the cement mortar is disposing a plurality of rifling structures in each of the drum mixers.

According to the above, the drum mixers is inclined relative to the pan mixer such that when the pan mixer pours the cement mortar into the drum mixers, the potential of the cement mortar in the drum mixers can be increased, and the cement mortar can be uniformly mixed with and coated on the coarse aggregate or the fiber.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention.

FIG. 1 is a schematic drawing of a high performance green concrete mixer according to an embodiment of the present invention.

FIG. 2 is a flow chart illustrating a high performance mixing method for green concrete according to an embodiment of the present invention.

FIG. 3 is a schematic drawing of a drum mixer according to an embodiment of the present invention.

### DESCRIPTION OF EMBODIMENTS

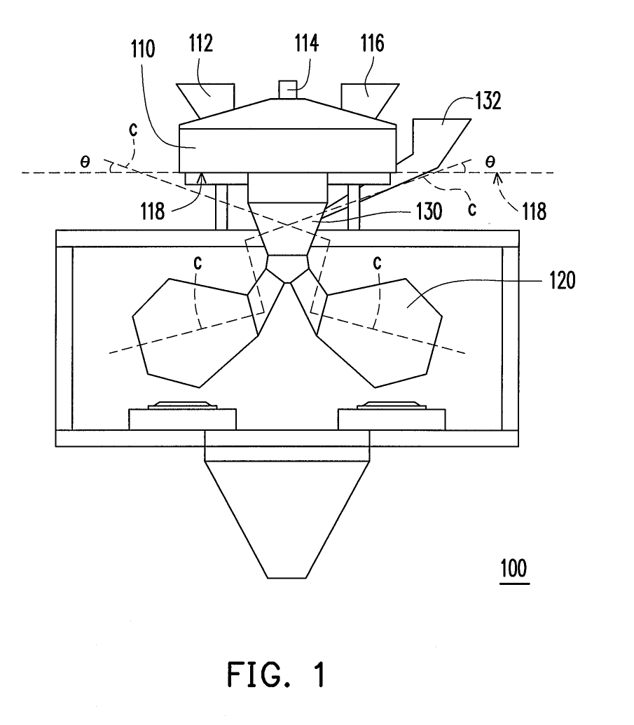

FIG. 1 is a schematic drawing of a high performance green concrete mixer according to an embodiment of the present invention. Referring to FIG. 1, the high performance green concrete mixer 100 comprises a pan mixer 110, a plurality of drum mixers 120 and a funnel 130. Each of the drum mixers 120 is inclined relative to the pan mixer 110, and the funnel 130 is connected between the pan mixer 110 and the drum mixers 120.

A top of the pan mixer 110 has a plurality of material inlets such as an admixture inlet 112, a cement inlet 114 and a fine aggregate inlet 116, and admixture, cement and fine aggregate are poured into the pan mixer 110 through their corresponding material inlets. In addition, the funnel 130 has a coarse-aggregate and fiber inlet 132.

Specifically, each of the drum mixers 120 is inclined relative to the pan mixer 110 by orienting a central axis C of each of the drum mixers 120 to include an acute angle with a bottom surface 118 of the pan mixer 110, so as to raise the position of inlets of the drum mixers 120.

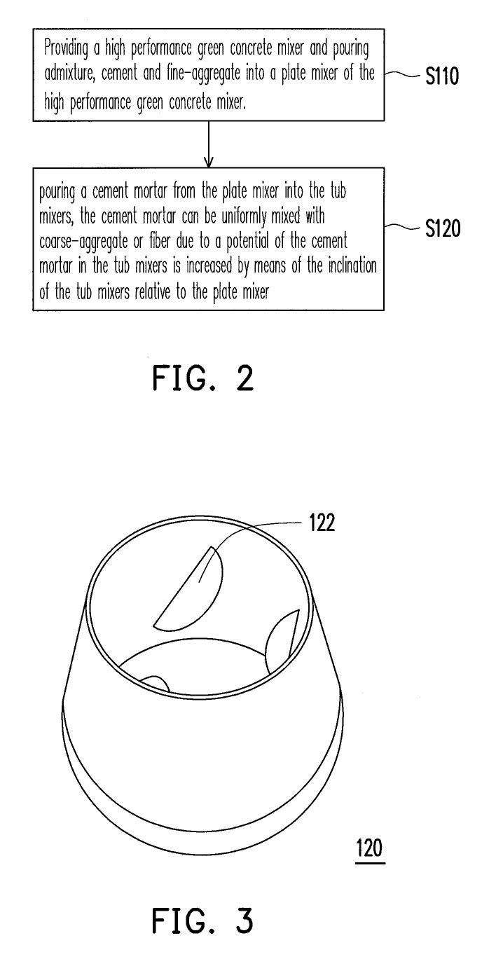

FIG. 2 is a flow chart illustrating a high performance mixing method for green concrete according to an embodiment of the present invention. Referring to FIGS. 1 and 2, as shown in step S110, the high performance green concrete mixer 100 is provided and the materials of cement mortar such as admixture, cement and fine aggregate are poured into the pan mixer 110 through the admixture inlet 112, the cement inlet 114 and the fine aggregate inlet 116. The admixture, the cement and the fine aggregate are uniformly mixed in the pan mixer 110 to form a cement mortar, and then the cement mortar passes into the drum mixers 120 through the funnel 130.

Then, as shown in step S120, the cement mortar is poured into the drum mixers 120, while coarse-aggregate and fiber are poured into the funnel 130 through the coarse-aggregate and fiber inlet 132 thereof. Each of the drum mixers 120 spins along its central axis C continuously to uniformly mix the cement mortar with the coarse aggregate and the fiber. It is noted that since the drum mixers 120 are inclined relative to the pan mixer 110, the position of the inlets of the drum mixers 120 can be raised, and when the cement mortar enters the drum mixers 120, the cement mortar drops and uniformly spreads on the coarse aggregate and the fiber due to the gravity effect. Compared with the conventional art, the drum mixers 120 are inclined relative to the pan mixer 110 to raise the potential of the cement mortar when entering the drum mixers 120, and therefore the cement mortar can be uniformly mixed with the coarse aggregate and the fiber. Since the uniformity of mixing the cement with the coarse aggregate or the fiber can be improved by raising the potential of the cement mortar, the consumption of cement and water as well as the production of carbon dioxide can be reduced, to decrease the material consumption, the power consumption and the mixing time of the high performance green concrete mixer 100.

FIG. 3 is a schematic drawing of a drum mixer according to an embodiment of the present invention. Referring to FIG. 3, the drum mixer 120 has a plurality of rifling structures 122 disposed radically therein. The cement mortar, the coarse aggregate and the fiber may stick on the inner wall of the drum mixer 120 as being mixed continuously therein. As the drum mixer 120 spinning, the rifling structures 122 can raise the dropping height of the cement mortar, the coarse-aggregate and the fiber, so as to increase the potential of the cement mortar, the coarse aggregate and the fiber to mix the cement mortar, the coarse aggregate and the fiber more uniformly and improve the mixing effect.

In sum, the high performance green concrete mixer provides the drum mixers inclined relative to the pan mixer to increase the potential of the cement mortar and improve the mixing effect, and accordingly the consumption of cement and water can be reduced to achieve low production of carbon dioxide, low material and power consumption and short mixing time.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A high performance green concrete mixer, comprising:
a pan mixer;
a plurality of drum mixers, wherein each of the drum mixers is inclined relative to the pan mixer; and
a funnel connected between the pan mixer and the drum mixers.

2. The high performance green concrete mixer as claimed in claim 1, wherein the pan mixer has a plurality of material inlets.

3. The high performance green concrete mixer as claimed in claim 1, wherein a central axis of each of the drum mixers and a bottom surface of the pan mixer includes an acute angle.

4. The high performance green concrete mixer as claimed in claim 1, wherein each of the drum mixers has a plurality of rifling structures disposed radically therein.

5. The high performance green concrete mixer as claimed in claim 1, wherein the funnel has a coarse aggregate and fiber inlet, through which coarse aggregate and fiber are poured into the funnel.

6. A high performance mixing method for green concrete, the method comprising:
providing a high performance green concrete mixer, wherein the high performance green concrete mixer comprises a pan mixer and a plurality of drum mixers, each of the drum mixers being inclined relative to the pan mixer; and
pouring a cement mortar from the pan mixer into the drum mixers, the cement mortar can be uniformly mixed with coarse aggregate or fiber due to a potential of the cement mortar in the drum mixers is increased by means of the inclination of the drum mixers relative to the pan mixer.

7. The high performance mixing method for green concrete as claimed in claim 6, wherein the step of disposing each of the drum mixers inclined relative to the pan mixer comprises orienting a central axis of each of the drum mixers to include an acute angle with a bottom surface of the pan mixer.

8. The high performance mixing method for green concrete as claimed in claim 6, wherein each of the drum mixers has a plurality of rifling structures disposed radically therein for increasing the potential of the cement mortar.
